(19) United States
(12) Patent Application Publication
(10) Pub. No.: US 2016/0258540 A1
(43) Pub. Date: Sep. 8, 2016

(54) GAS FLOW REGULATOR, REDUCING VALVE, VALVE AND BOTTLE FITTED WITH SUCH A REGULATOR

(71) Applicant: L'AIR LIQUIDE, SOCIETE ANONYME POUR L'ETUDE ET L'EXPLOITATION DES PROCEDES GEORGES CLAUDE, Paris (FR)

(72) Inventors: Damien GERMANI, Paris (FR); Philippe RUDNIANYN, Villiers sur Orge (FR); Vincent GRAVIERE, Ivry sur Seine (FR); Adrien TREVISAN, Neuilly sur Seine (FR)

(21) Appl. No.: 15/030,277

(22) PCT Filed: Sep. 5, 2014
(86) PCT No.: PCT/FR2014/052200

§ 371 Date: Apr. 18, 2016

(30) Foreign Application Priority Data
Oct. 18, 2013 (FR) 1360166

(51) Int. Cl. F16K 3/32; F16K 3/08

(52) U.S. Cl. CPC F16K 3/32; F16K 3/08

(57) ABSTRACT

A flow regulator comprising a body housing a gas duct comprising an upstream end configured to be connected to a gas source and a downstream end comprising an outlet connector and configured to be connected to a gas user with a regulated flow rate, the gas duct comprising a selective fluid flow regulation component for the gas circulating between the upstream and downstream end depending on the position of the control component with respect to the body, wherein the control component comprises a peripheral wall delimiting a central hollow volume and in that the outlet connector is situated within the central cavity.

### CROSS REFERENCE TO RELATED APPLICATIONS

This application is a 371 of International PCT Application PCT/FR2014/052200 filed Sep. 5, 2014 which claims priority to French Patent Application No. 1360166 filed Oct. 18, 2013, the entire contents of which are incorporated herein by reference.

### BACKGROUND

The present invention concerns a gas flow regulator and a reducing valve, a valve and a bottle fitted with such a regulator.

### SUMMARY

The invention more particularly concerns a gas flow regulator including a body accommodating a gas duct including an upstream end intended to be connected to a source of gas and a downstream end including an outlet connector and intended to be connected to a user of the gas with a regulated flow rate, the gas duct including a member for selective regulation of the flow of fluid circulating between the upstream and downstream ends, the flow regulator including a manual control member mounted to be mobile relative to the body and cooperating with the member for regulating the flow of fluid to control the flow rate of fluid allowed to pass from the upstream end to the downstream end according to the position of the control member relative to the body.

The invention applies in particular to a gas valve incorporating a flow regulator for the gas drawn off.

Pressurized gas bottle valves, notably those with an integral pressure reducing valve, generally include a flow regulator for the gas drawn off enabling the user to adjust manually the required quantity of gas.

The corresponding valves then have a user interface that is relatively complex because it includes:
a plurality of connectors (a filling connector, a pressure outlet connector, a flow outlet connector),
a plurality of control members (opening/closing the valve for isolating the drawing off circuit and a control for adjusting the flow rate).

All these components are situated in a restricted volume, especially in the case of a gas bottle valve when the bottle can be transported manually and is fitted with a cap to protect the valve. This makes it more difficult for a user to understand how the valve works and therefore increases the risk of errors.

An object of the present invention is to alleviate some or all of the drawbacks of the prior art summarized above.

To this end, the flow regulator in accordance with the invention, otherwise conforming to the generic definition thereof given in the above preamble, is essentially characterized in that the control member includes a peripheral wall delimiting a central hollow volume and in that the outlet connector is situated in said central hollow volume.

In accordance with particular features:
the exterior peripheral wall of the control member delimits a hollow volume open toward the exterior of the regulator,
the outlet connector opens onto and/or projects toward the exterior of the regulator,
the outlet connector opens into the hollow volume,
the control member surrounds the outlet connector with a gap,
the outlet connector is an oblong male connector,
the hollow volume is delimited by an interior wall of the control member, this interior wall is spaced from the outlet connector and forms a protective enclosure around the outlet connector,
the protective enclosure forms a concave cup in which the connector is situated,
the interior wall delimiting the protective enclosure around the connector is parallel to the longitudinal axis of the outlet connector,
the interior wall delimiting the protective enclosure around the connector is inclined relative to the longitudinal axis of the outlet connector and diverges transversely toward the exterior of the regulator, i.e. the distance between the interior wall and the outlet connector is greater at the level of the terminal end of the connector than at the level of the bottom of the hollow volume,
the control member includes concentrically around its interior wall a exterior peripheral wall disposed for grasping it,
the hollow volume is open toward the exterior of the regulator, i.e. access to the outlet connector from the exterior of the regulator to enable the fluidic connection of drawing off means to the outlet connector is not impeded, the grasping member forming around the outlet connector a sheath open at its longitudinal end and transversely spaced relative to the outlet connector,
a plurality of different positions of the control member corresponds to a plurality of respective different flow rates established by the flow regulation member.

Apart from the fact that it makes it possible to reduce the overall size of the valve, this arrangement confers ergonomic features that make the associated functions immediately obvious to the user. In actual fact, even an inexperienced user understands the functional link between the knob for adjusting the flow rate and the connector via which the gas is delivered at the corresponding flow rate.

Grouping these two functions together in the same volume enables improved successive use of these functions (connection of a hose to the outlet connector and then selection of a flow rate via the control member).

This arrangement makes it possible to dispose the other functions and members of the valve with greater flexibility and more options.

Moreover, this architecture makes it possible to protect the outlet connector inside a functional control component. This also makes it possible to protect the end of a hose connected to the outlet connector inside the hollow volume, if necessary. In actual fact, in such a configuration, the end of the hose connected to the outlet connector is mechanically protected by the wall of the control member.

Moreover, embodiments of the invention may have one or more of the following features:
the control member includes a portion of tubular, frustoconical or ring general shape, the outlet connector being situated in the central portion of said tubular, frustoconical or ring shape,
the portion of tubular, frustoconical or ring general shape opens onto and is open toward the exterior of the regulator to allow direct access to the outlet connector,
the control member and the outlet connector are concentrically, for example coaxially, disposed,
the control member is mobile in rotation on the body about a rotation axis,
the control member is mobile in rotation on the body about an axis of rotation and of symmetry passing through its central hollow volume and the outlet connector is fixed relative to the body and is situated on said rotation axis of the control member,
the flow regulation member includes a plate including calibrated holes with respective different diameters corresponding to particular different gas flow rates, the control member selecting a particular one of the calibrated holes on the path of the gas in the gas duct according to the position of the control member relative to the body,
the flow regulation member is mounted to be mobile relative to the body and constrained to move with the control member, the body including a passage a first end of which communicates with the downstream end of the gas duct and the other end of which communicates with the calibrated holes on a first face of the regulation member, the calibrated holes being disposed in turn between the upstream and downstream ends of the gas duct according to the positions of the control member relative to the regulation body,
the control member is mounted to be mobile in rotation relative to the body, the flow regulation member being constrained to rotate with the control member, particular angular positions of the control member and of the regulation member relative to the body respectively disposing the calibrated holes between the upstream and downstream ends of the gas duct,
the flow regulation member is fixed relative to the body, the control member being mobile relative to the flow regulation member and including a passage a first end of which communicates with the downstream end of the gas duct and the other end of which is able to communicate in a sealed manner and successively with each of the calibrated holes on a first face of the regulation member according to the positions of the control member relative to the regulation member.
the outlet connector has an oblong shape and, in a direction parallel to the longitudinal axis of the outlet connector, the terminal end of the outlet connector is situated at the level of or set back from the terminal end of the control member,
the flow regulator includes, at the level of the downstream end of the gas duct, a male or female connector intended to cooperate in selective attachment with a conjugate female or male gas connector of a source of gas such as a wall gas outlet or a gas valve with or without a pressure reducing valve, to mount the gas regulator selectively on said gas connector of the source and to connect the upstream end of the gas duct with the gas delivered by the gas source,
the gas circuit of the reducing valve includes an isolating valve,
the control member includes a mounting first portion mounted on the body of the outlet connector, the mounting first portion being connected to a holding second portion having dimensions greater than the mounting first portion and delimiting the hollow volume around the outlet connector,
the outside diameter of the outlet connector is between 3 and 30 mm inclusive and the inside diameter of the central hollow volume of the control member is between 20 and 150 mm inclusive so that the peripheral wall of the control member is spaced from the outlet connector by a distance between 5 and 40 mm inclusive,
at least a portion of the peripheral wall of the control member delimiting a hollow volume projects relative to the body of the valve to enable it to be grasped manually,
the flow regulator includes an intermediate support to which the outlet connector is fixed, said intermediate support including an internal passage communicating with a collecting groove in communication with the calibrated holes at the level of a second face of the regulation member,
the outlet connector is in one piece with or fastened to the body of the flow regulator.

The invention also concerns a pressure reducing valve intended to be connected to a source of gas under pressure, the reducing valve including a body accommodating a gas circuit having an upstream end including an inlet connector intended to be connected selectively to a source of pressure such as an outlet connector of a gas valve and a downstream end including an outlet connector intended to be connected to a user of the gas at reduced pressure, the gas circuit including a pressure reducing valve adapted to reduce the pressure of the gas circulating in the gas circuit to a particular fixed or adjustable pressure, the reducing valve including a flow regulator having any one of the above features or the following features and the outlet connector of the flow regulator constituting an outlet connector of the reducing valve.

The invention also concerns a valve for a pressurized fluid, notably pressurized gas, bottle including a valve body including a mounting end intended to be connected to an orifice of a gas bottle, an internal circuit for drawing off the fluid including a first end opening at the level of the mounting end and a second end opening at the level of an outlet connector situated on the valve body, the valve including a flow regulator having any one of the above features or the following features in which the outlet connector of the flow regulator constituting an outlet connector of the valve.

In accordance with other possible features:
the flow regulation member includes a plate including calibrated holes with respective different diameters corresponding to particular different gas flow rates, the control member selecting a particular calibrated hole on the path of the gas in the gas drawing off circuit according to the position of the control member relative to the body of the valve,
the control member and the flow regulation member are mobile together relative to the body of the valve, the body of the flow regulator includes a passage a first end of which communicates with the drawing off circuit in the outlet connector and the other end of which communicates with the calibrated holes on a first face of the regulation member, the calibrated holes being disposed in turn on the drawing off circuit according to the respective positions of the control member relative to the body of the valve.

The invention may also concern a pressurized fluid bottle including a valve having any one of the above features or the following features.

The invention may also concern any alternate device or method having any combination of the above features or the following features.

### BRIEF DESCRIPTION OF THE DRAWINGS

Other particular features and advantages will become apparent on reading the following description given with reference to the figures, in which:

FIG. 1 represents a diagrammatic and partial view in longitudinal section illustrating a possible first embodiment of a flow regulator in accordance with the invention,

FIG. 2 represents a diagrammatic and partial perspective view illustrating a valve incorporating a flow regulator according to FIG. 1,

FIG. 3 represents a diagrammatic and partial side view of the valve from FIG. 2 mounted on a gas bottle,

FIG. 4 represents a diagrammatic and partial view in section illustrating the possible use of a flow regulator in accordance with the invention to regulate a flow of gas at the level of a wall gas outlet,

FIG. 5 represents a diagrammatic and partial view in section illustrating a gas reducing valve able to use a flow regulator in accordance with the invention,

FIG. 6 represents a diagrammatic and partial view in section of a detail of a valve incorporating a flow regulator conforming to another embodiment.

### DESCRIPTION OF PREFERRED EMBODIMENTS

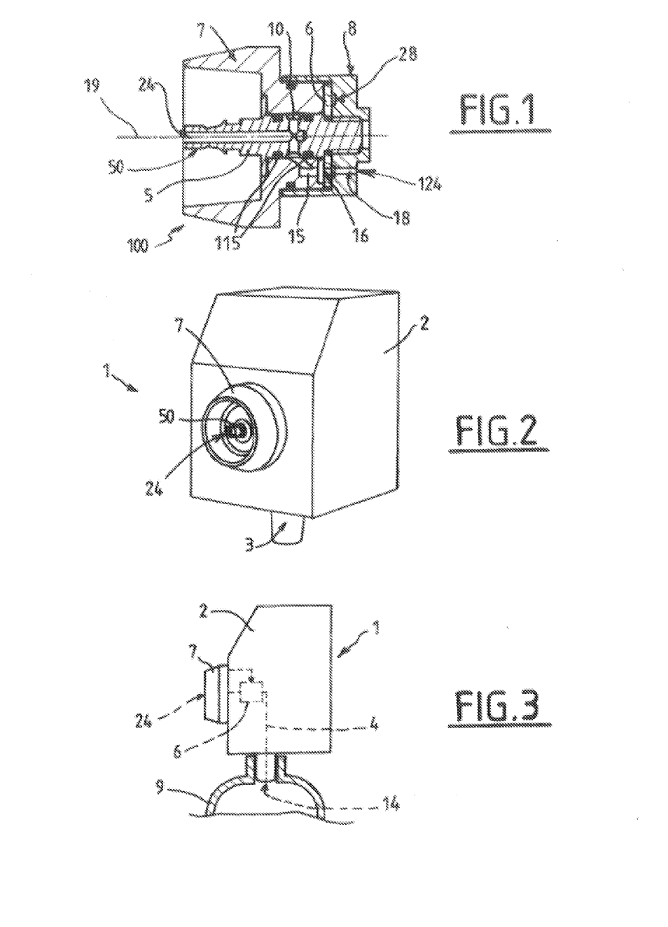

The valve 1 in FIG. 2 includes a body 2 the contour of which is diagrammatic and simplified. This body 2 has a mounting end 3 that can be the lower end (and can be threaded) intended to be connected (for example screwed) into an orifice of a bottle 9 of fluid such as gas under pressure (cf. FIG. 3).

The body 2 contains an internal gas circuit 4 for drawing off the fluid. This internal circuit 4 has an upstream first end 14 opening at the level of the mounting end 3 and a second end 24 opening at the level of an outlet connector 50 situated on the body 2 (the drawing off circuit 4 is shown diagrammatically in dashed line in FIG. 3).

The drawing off circuit 4 includes a member 6 for selectively regulating the flow rate of the fluid circulating in the drawing off circuit 4. The valve 1 includes a manual control member 7 mounted to be mobile relative to the body 2 and selectively actuating the flow regulation member 6 to regulate the flow of fluid drawn off. For example, the control member 7 is mechanically coupled to the selective regulation member 6 so that a movement of the former (control member 7) modifies by reaction the configuration and therefore the flow set point established by the latter (regulation member).

As can be seen in FIGS. 1 to 3, the control member 7 includes a peripheral wall delimiting a central hollow volume and the outlet connector 50 is situated in the central hollow volume.

For example, and as shown, the control member 7 has a grasping end projecting at least in part on the body 2 and defining a cavity. For example, the control member 7 includes a grasping end of tubular or conical or any other appropriate shape.

The outlet connector 50 is situated in the internal portion of said cavity.

The control member 7 and the outlet connector 50 are preferably disposed concentrically. The control member 7 and the outlet connector 10 are more preferably coaxial.

For example, the control member 7 is mounted to be mobile in rotation on the body 2 about its longitudinal axis of symmetry and the outlet connector 50 has a male end situated on that axis of symmetry and of rotation (cf. FIG. 1). The outlet connector 50 is preferably fixedly mounted on the body 2 of the valve 1.

Accordingly, the rotation of the control member 7 on itself configures the flow regulation member 6 to increase or to decrease the flow allowed to exit via the outlet connector 50. To this end, the control member 7 may carry graduations cooperating with the body 2 or some other marker to indicate to the user the selected flow rate.

As can be seen in FIGS. 1 and 3, the terminal end of the outlet connector 50 is preferably set back from the terminal end of the control member 7 (to protect the connector 50 from impacts).

Of course, this terminal end of the outlet connector 50 may be situated at the level of (i.e. in the same plane transverse to the axis of the connector 50 as) or project relative to the terminal end of the control member 7.

Moreover, and notably as a function of dimensional standards imposed by regulations in various countries, the outside diameter of the outlet connector 50 may be between 3 and 30 millimeters inclusive and the inside diameter of the cavity of the control member 7 may be between 20 millimeters (when the outside diameter of the connector is less than that value) and 150 millimeters inclusive.

The peripheral wall of the control member 7 may be spaced from the outlet connector 50 by a distance between 5 and 40 millimeters inclusive. This spacing is preferably sufficient to allow the fingers of a user access in order to connect/detach a hose to/from the connector 50. This makes it possible to connect a female end of a hose of an appliance using the gas to the outlet connector 50 inside the volume of the control member 7.

As shown in FIG. 1, the control member 7 may include a mounting first portion (on the right in FIG. 1) mounted on and sealed to the body of the outlet connector 50. This mounting first portion is connected to a second portion (on the left in FIG. 1) having a diameter greater than the tubular first portion and delimiting the hollow volume around the outlet connector 50. For example, the connector 50 is fixed (for example screwed) to an intermediate support 8 intended to be fixed to the body 2 of the valve 1. Of course, and as described later, the connector 50 may be fixed directly to the valve body 2 or other body.

The flow regulation member 6 may include a plate (or disk) including calibrated holes 16 with respective different diameters corresponding to particular different drawing off rates. According to its position relative to the body 2, the control member 7 selects a particular calibrated hole 16 on the path of the fluid.

This regulation member 6 is for example fixedly mounted relative to the body 2 of the valve while the control member 7 is mobile relative to the regulation member 6.

As can be seen in the FIG. 1 example, the control member 7 includes a passage 15 a first end of which communicates with the drawing off circuit in the connector 50 (toward the terminal end of the connector 50). According to the position of the control member 7 relative to the outlet member 6, a second end of this passage 15 is able to communicate (or not) in sealed manner with a particular calibrated hole 16 on a first face of the regulation member 6.

The intermediate support 8 (or the body 2 of the valve if there is no intermediate support 8) may include an internal passage 18 communicating via a collector groove 28 with all the orifices 16 at the level of a second face of the regulation member 6.

The gas the outlet flow rate of which is to be adjusted therefore reaches via the passage 18 pierced in the support 8 the collector groove 28 created between the control member 7 and the support 8. This collector groove 28 is in communication with each of the calibrated holes 16 in the disk 6.

The passage 15 of the regulation member 7 is positioned in a sealed manner on the other face at the level of a calibrated hole 16 corresponding to the required flow rate by the rotation of the knob 2 that is maneuvered by the user. In this example the control member 7 is mobile in rotation relative to the support 8. In this example the disk 6 with calibrated holes 16 is fixed in rotation relative to the support 8 and to the outlet connector 50.

The gas passes through the selected calibrated hole 16 and the passage 15 formed in the control member 7 and reaches a sealed groove 10 between the outlet connector 50 and the control member 7. A duct in the outlet connector 50 enables communication between the terminal outlet orifice of the outlet connector 50 and this groove 10 between the control member 7 and the outlet connector 50. Seals 115 positioned on either side of said groove 10 make it possible to guarantee that the outlet orifice is fed with gas at the required flow rate.

This arrangement makes it possible for the outlet connector 50 to be fixed in rotation relative to the body 2 (or support 8). The fixed character of the outlet connector 50 makes it possible not to induce any rotation movement of the outlet connector 50 (and consequently rotation of the hose that is connected to it) on rotating the control member 7.

Alternatively, and as described in more detail hereinafter by way of an example, the disk 6 including the calibrated orifices 16 may be mobile in rotation with the control member 7 or in one piece therewith and the outlet connector 50 remain fixed.

As can be seen, the outlet connector 50 may have a geometry (transverse shoulder) enabling axial stopping of the flow control member 7.

As explained above, the support function of the component 8 may be provided by the body 2 of the valve 1 itself or by a component separate from the body 2 and fixed to or integral with the latter.

Of course, the flow regulator in accordance with the invention is not necessarily integrated into a gas valve and may be structurally independent and usable to regulate a flow from any other gas source.

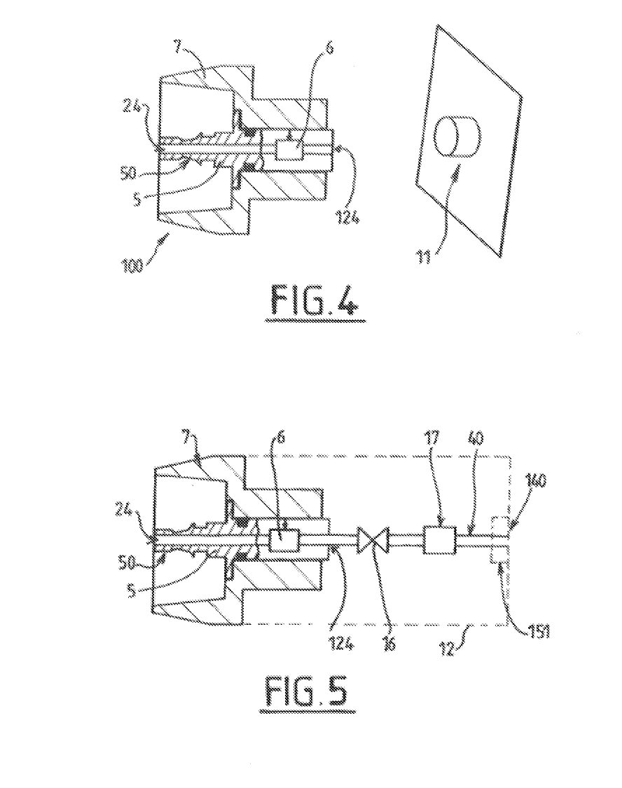

For example, as shown in FIG. 4, the flow regulator may include, at the level of the upstream end 124 of its internal gas duct, a male or female connector intended to cooperate through selective attachment with a conjugate female or male gas connector of a gas outlet 11, for example a wall gas outlet.

For simplicity, elements identical to those described above are designated by the same reference numbers and are not described again.

Likewise, the flow regulator may be integrated with (or selectively connectable to) a pressure reducing valve independent of a valve.

As shown in FIG. 5, a pressure reducing valve may include a flow selector as described above.

The pressure reducing valve is for example intended to be connected to a pressurized gas source such as a pressurized gas valve.

The reducing valve includes for example a body 12 accommodating a gas circuit 40 having an upstream end 140 including an inlet connector 15 intended to be connected selectively to a source of pressure such as an outlet connector of a gas valve.

The gas circuit 40 of the reducing valve has a downstream end 24 including an outlet connector 50 intended to be connected to a user of the pressure reduced gas.

The gas circuit 40 includes a pressure reducing valve 17 adapted to reduce the pressure of the gas circulating in the gas circuit 40 to a particular fixed or variable pressure. An isolating valve 16 (integrated into the reducing valve 17 or not) may also be provided on the gas circuit 40. The valve 16 may be situated on the upstream or downstream side of the reducing valve 17. The reducing valve incorporates a flow regulator as described above. The outlet connector 50 of the flow regulator can therefore constitute the outlet connector of the reducing valve.

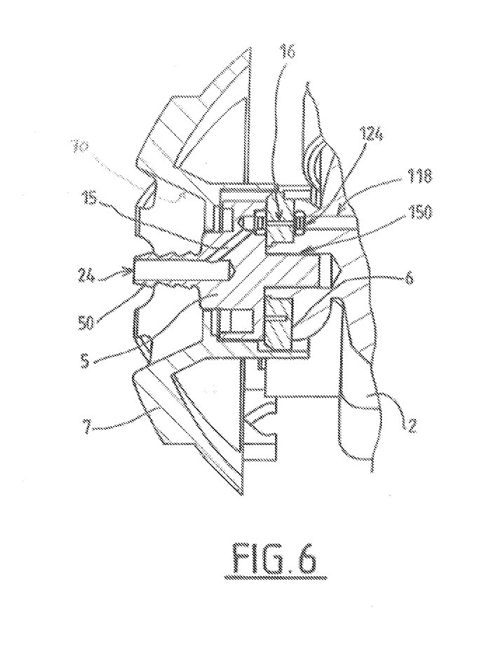

FIG. 6 illustrates a further possible variant embodiment of the flow regulator. Elements identical to those described above are designated by the same reference numbers. In the FIG. 6 example the flow regulator is incorporated in a valve body 2 (represented in part). Of course, and as before, this flow regulator may be independent and/or integrated into a pressure reducing valve.

In the FIG. 6 embodiment the outlet connector 50 is mounted on the body 2 of the valve. For example, an end 150 of the connector 50 is fastened, notably screwed, to the body 2 of the valve.

The flow regulation member 6 including the calibrated holes 16 is mounted between the outlet connector 50 and the body 2 of the valve, for example. This flow regulation member 6 has the general shape of a disk, for example.

The control member 7 is disposed concentrically around the outlet connector 50. The control member 7 has the general shape of a circular knob, for example, the hollow central portion of which accommodate the outlet connector 50. The control member 7 is mounted on the body 2 to rotate about the fixed outlet connector 50.

The flow regulation member 6 is mounted so that it is free to rotate about the outlet connector 50. The flow regulation member 6 is constrained to rotate with the control member 7.

The connector 50 includes a passage 15 a first end of which communicates with the drawing off circuit in the connector 50 (toward the terminal end of the connector 50). According to the angular position of the control member 7 relative to the body 2, a second end of this passage 15 can communicate in sealed manner with a particular calibrated hole 16 on a first face of the regulation member 6. The second face of the regulation member 6 communicates in a sealed manner with a gas feed duct 118.

In this way, when the operator turns the control member 7, they select in turn either a portion with no calibrated hole or one of the calibrated holes 16, depending on the distribution of the calibrated holes on the regulation member 6. For example, after a portion without calibrated holes, the subsequent positions (on continued rotation in the same direction) successively select different calibrated holes 16.

By selecting a particular calibrated hole 16, the device ensures a flow of gas between the duct 118 and the passage 15 of the outlet connector 50 with a particular flow rate. In a particular position of the control member 7 in which a portion with no calibrated holes is selected, this prevents drawing off.

In this configuration, the outlet connector 50 is fixed whereas the regulation member 6 with the calibrated holes 16 is mobile with the control member 7. The device may conventionally include a notching mechanism (not shown for simplicity) making it possible to define stable reference positions of the lever relative to the outlet connector 50. These stable positions correspond to closing the gas path (no calibrated orifice 16 facing the passage 15) or selecting a particular orifice 16 to allow drawing off.

1.-15. (canceled)

16. A gas flow regulator comprising a body comprising a gas duct comprising an upstream end configured to be connected to a source of gas and a downstream end comprising an outlet connector and configured to be connected to a user of the gas with a regulated flow rate, the gas duct also comprising a flow regulator for selective regulation of the flow of the gas flowing between the upstream end and the downstream end, the flow regulator comprising a manual control member configured to be movable relative to the body and cooperating with the flow regulator to control the flow rate of gas, with the flow rate indicated by the position of the manual control member relative to the body, wherein the manual control member comprises a grasping peripheral wall delimiting a central hollow volume open toward the exterior of the regulator and wherein the outlet connector is situated in and opens into the central hollow volume, the hollow volume being delimited by a wall of the manual control member forming a protective enclosure around the outlet connector and spaced from the latter.

17. The flow regulator of claim 16, wherein the manual control member further comprises a portion of tubular, frustoconical or ring general shape and wherein the outlet connector is situated in the central portion of said tubular, frustoconical or ring shape.

18. The flow regulator of claim 16, wherein the manual control member and the outlet connector are concentrically disposed.

19. The flow regulator of claim 16, wherein the outlet connector has an oblong shape extending along a longitudinal axis and wherein, in a direction parallel to the longitudinal axis of the outlet connector, the terminal end of the outlet connector is situated at the level of or set back from the terminal end of the manual control member.

20. The flow regulator of claim 16, wherein the manual control member is movable in rotation on the body about a rotation axis.

21. The flow regulator of claim 16, wherein the manual control member is movable in rotation on the body about an axis of rotation and of symmetry passing through the central hollow volume and wherein the outlet connector is fixed relative to the body and is situated on the rotation axis of the manual control member.

22. The flow regulator of claim 16, wherein the flow regulator comprises a plate including sets of calibrated holes, with respective different diameters corresponding to particular different gas flow rates, the manual control member configured to select a particular set of the calibrated holes on the path of the gas determined by the position of the manual control member relative to the body.

23. The flow regulator of claim 22, wherein the flow regulator is configured to be movable relative to the body and constrained to move with the manual control member, the body comprising a passage a first end of which communicates with the downstream end of the gas duct and the second end of which communicates with the set of calibrated holes on a first face of the flow regulator, the set of calibrated holes configured to turn between the upstream end and the downstream end of the gas duct.

24. The flow regulator of claim 23, wherein the manual control member is configured to be movable in rotation relative to the body and in that the flow regulator is constrained to rotate with the manual control member.

25. The flow regulator of claim 22, wherein the flow regulator is fixed relative to the body and in that the manual control member is movable relative to the flow regulator and comprises a passage a first end of which communicates with the downstream end of the gas duct and the second end of which is able to communicate in a sealed manner with each of the set of calibrated holes on a first face of the flow regulator.

26. A pressure reducing valve configured to be connected to a source of gas under pressure, the reducing valve comprising a body accommodating a gas circuit having an upstream end including an inlet connector configured to be connected selectively to a source of pressure such as an outlet connector of a gas valve and a downstream end including an outlet connector configured to be connected to a user of the gas at reduced pressure, the gas circuit comprising a pressure reducing valve configured to reduce the pressure of the gas circulating in the gas circuit to a particular fixed or adjustable pressure, wherein the pressure reducing valve comprises a flow regulator as claimed in claim 16, wherein the outlet connector of the flow regulator comprises an outlet connector of the pressure reducing valve.

27. A valve for a pressurized gas bottle comprising a valve body comprising a mounting end configured to be connected to an orifice of a gas bottle, an internal circuit for drawing off the fluid comprising a first end opening at the level of the mounting end and a second end opening at the level of an outlet connector situated on the valve body, wherein the valve comprises a flow regulator as claimed in claim 16, wherein the outlet connector of the flow regulator constitutes an outlet connector of the valve.

28. The valve of claim 27, wherein the flow regulator comprises a plate including sets calibrated holes with different diameters corresponding to respective particular different gas flow rates, the manual control member selecting a particular calibrated hole on the path of the gas in the gas drawing off circuit as claimed in the position of the manual control member relative to the body of the valve.

29. The valve of claim 28, wherein the manual control member and the flow regulator are movable together relative to the body of the valve, the body of the flow regulator includes a passage a first end of which communicates with the drawing off circuit in the outlet connector and the other end of which communicates with the calibrated holes on a first face of the flow regulator, the set of calibrated holes being configured in turn on the drawing off circuit as claimed in the respective positions of the manual control member relative to the body of the valve.

30. A pressurized fluid bottle including the valve of claim 27.
